(19) United States
(12) Patent Application Publication
(10) Pub. No.: US 2013/0180620 A1
(43) Pub. Date: Jul. 18, 2013

(54) CARBON DIOXIDE SUPPLY FOR INJECTION-MOLDING SYSTEMS

(71) Applicant: Andreas Praller, Germering (DE)

(72) Inventor: Andreas Praller, Germering (DE)

(21) Appl. No.: 13/531,965

(22) Filed: Jun. 25, 2012

Related U.S. Application Data
(63) Continuation-in-part of application No. 11/794,408, filed on Mar. 19, 2008, now abandoned.

(30) Foreign Application Priority Data
Jan. 21, 2005 (DE) 102005002976.0

(51) Int. Cl. F17C 5/02

(52) U.S. Cl. CPC F17C 5/02
USPC 141/11; 141/82

(57) ABSTRACT

For supplying a sink with liquid carbon dioxide with a required temperature of more than 0° C. and with a required pressure of more than 30 bar, liquid carbon dioxide is taken from a tank, in which it has been stored at a temperature below the required temperature and at a pressure below the required pressure. The pressure of the carbon dioxide is increased and then the carbon dioxide is heated to the required temperature.

### CROSS REFERENCE TO RELATED APPLICATIONS

This application is a continuation in part of U.S. patent application Ser. No. 11/794,408 filed Mar. 19, 2008 which claims priority from International Patent Application No. PCT/EP20061000143, filed Jan. 10, 2006, claiming priority from German Patent Application No. 1020050029, filed Jan. 21, 2005.

### BACKGROUND OF THE INVENTION

The invention relates to a method for supplying a sink with liquid carbon dioxide with a required temperature of more than 0° C. and with a required pressure of more than 30 bar. The invention moreover relates to an apparatus for supplying a sink with liquid carbon dioxide under the conditions mentioned.

Carbon dioxide is one of the materials used for cooling of injection molds. To this end, capillary tubes or expansion nozzles are supplied with liquid carbon dioxide free from bubbles, and this expands in the capillary tubes and thus withdraws heat from the injection mold.

For uniform and reproducible cooling, it is important that the carbon dioxide is supplied to the mold with a certain required pressure of from 40 to 70 bar and with a fixed required temperature in the region of the ambient temperature. It is necessary to comply with the “warm” temperature range in order to avoid condensation of atmospheric moisture on the lines through which the carbon dioxide passes and on the injection molds. Moisture or water droplets dripping into the injection molds actually affect the quality of the moldings produced and risks corrosion of the molds.

Carbon dioxide with the abovementioned pressure properties and temperature properties is usually taken from what is known as a medium-pressure tank, in which the carbon dioxide has previously been stored within the desired pressure range of about 50 to 70 bar and within the corresponding boiling point of from 15 to 25° C. The liquid carbon dioxide is conducted from the medium-pressure tank by way of pipelines to one or more injection molds.

The cooling of the molds is normally controlled and adjusted by way of time cycles of a magnetic valve in the line to the injection mold. For reproducible cooling it is necessary that the pressure and the temperature of the carbon dioxide prior to the magnetic valve are always of the same magnitude. If, by way of example in summer, the temperature in the production building is higher than the boiling point corresponding to the tank pressure, some of the carbon dioxide can evaporate before it leaves the pipeline connecting the medium-pressure tank to the mold, the result of this being poorer and less uniform cooling.

It is therefore an object of the present invention to provide a method and a corresponding apparatus for supplying a sink with liquid carbon dioxide while avoiding the abovementioned problems.

### SUMMARY OF THE INVENTION

This object is achieved via a method of the type described above, where the carbon dioxide is taken from a tank in which the liquid carbon dioxide has been stored at a temperature below the required temperature and at a pressure below the required pressure, and the pressure of the carbon dioxide is increased and then the carbon dioxide is heated to the required temperature.

In one embodiment of the invention, there is disclosed a method for the supply of a sink with liquid carbon dioxide with a desired temperature of more than 0° C. and a desired pressure of more than 30 bar, characterized in that the carbon dioxide is taken from a tank in which the liquid carbon dioxide is stored at a temperature below the desired temperature and a pressure below the desired pressure, that the pressure of the carbon dioxide is increased and that subsequently the carbon dioxide is heated to the desired temperature in the immediate vicinity of the sink.

In a further embodiment of the invention, there is disclosed a device for the supply of a sink with liquid carbon dioxide with a desired temperature of more than 0° C. and a desired pressure of more 30 bar, characterized through a single tank in which the liquid carbon dioxide is stored at a temperature below the desired temperature and a pressure below the desired pressure, a supply line connecting the single tank with the sink, a pressure boosting apparatus to increase the pressure of the carbon dioxide supplied to the sink wherein the pressure boosting apparatus is within 1 meter of the single tank and said carbon dioxide is in a state of equilibrium prior to the pressure increase and a heater arranged downstream of the pressure boosting apparatus for heating the carbon dioxide according to the requirements of the sink.

According to the invention, liquid carbon dioxide is taken from a tank in which it has been stored at a pressure below the required pressure demanded and at a temperature below the required temperature. The liquid carbon dioxide is then, preferably in the immediate vicinity of the tank, supplied to a pressure-increasing system by means of which the pressure of the carbon dioxide is increased, and specifically and preferably to the desired required pressure. By virtue of the inventive pressure increase, the carbon dioxide becomes subcooled, and this means that the temperature of the carbon dioxide is below the boiling point corresponding to the increased pressure. The result of this is that the carbon dioxide does not evaporate during onward transport to the sink, and remains liquid. In the closest possible vicinity of the sink, the carbon dioxide is then heated to the required temperature and supplied in liquid form to the sink. The inventive method ensures that no carbon dioxide evaporates between the tank and the sink, and that liquid carbon dioxide is always available at the sink.

It is preferable that the carbon dioxide is taken from a low-pressure tank with a pressure of from 10 to 30 bar and with a corresponding boiling point of from about −40° C. to −10° C. It is particularly preferable to use a low-pressure tank with a pressure of from 14 to 25 bar. The pressure of the carbon dioxide is then preferably increased to 40 to 90 bar, particularly preferably from 50 to 70 bar.

The pressure-increasing system used preferably comprises a pneumatically or hydraulically operated compressor. A result of this is that it is possible to pass the carbon dioxide directly by way of a stub line to the sink after the pressure increase, without any need to conduct a portion of the carbon dioxide back again into the tank or into any other pressure vessel or intermediate tank. However, it is also equally possible to use an electrically operated compressor or a centrifugal pump or reciprocating pump, these requiring return of at least a portion of the carbon dioxide into the tank.

After the pressure increase, the condition of the carbon dioxide is markedly subcooled, and this means that its temperature is markedly below the boiling point corresponding to the pressure of the carbon dioxide. No evaporation of liquid carbon dioxide takes place under these conditions.

Prior to the pressure increase, the carbon dioxide is in the equilibrium state, and this means that it has not yet been subcooled. In this state, carbon dioxide can evaporate if appropriate heat is supplied. For this reason, the pressure-increasing system is provided in closest possible vicinity of the carbon dioxide tank. The line length between the tank and the pressure-increasing system is preferably less than 2 meters, particularly preferably less than 1 meter.

It has moreover proven advantageous to provide, in the line between the carbon dioxide tank and the sink, a buffer vessel in which liquid carbon dioxide can be placed into intermediate storage. It is preferable to provide a buffer vessel with a capacity of from 5 to 50 kg of carbon dioxide, particularly preferably from 10 to 30 kg of carbon dioxide, downstream of the heater immediately prior to the sink. A buffer vessel that can be used in particular is a siphon-tube bottle.

If a plurality of sinks are supplied with liquid carbon dioxide from one carbon dioxide tank it is also possible for the buffer vessel used to comprise a collection of bottles with capacity, by way of example, of up to 450 kg of carbon dioxide.

The heating of the carbon dioxide preferably takes place to a temperature in the range of 5° C. to 25° C., particularly preferably from 10° C. to 20° C. An advantage of the use of this approximately ambient temperature temperature range is that condensation at atmospheric pressure is substantially avoided on the sink and on the lines through which the carbon dioxide passes. Atmospheric moisture can actually be undesired, depending on the application sector. For example, in the use of carbon dioxide for cooling injection molds, moisture is to be avoided since it can lead to corrosion of the molds or has adverse effects on the surfaces of the injection moldings produced in the molds.

The manner of heating of the liquid carbon dioxide is to be such that during the heating process and between the heater and the sink no evaporation takes place. Heaters that can be used are air evaporators, water evaporators or an electrically operated heater. For reasons of space and of operating-risk reduction and of control accuracy, it is preferable to use an electrically operated heater. The heater is preferably arranged in the immediate vicinity of the sink.

The electrically operated heater is dimensioned in such a way that in batchwise operation, too, no liquid carbon dioxide can evaporate. To this end, it is advantageous to provide the heater with a metal block, preferably with an aluminum block, through which the liquid carbon dioxide passes. The temperature of the metal block is controlled precisely and adjusted appropriately for the pressure of the carbon dioxide in such a way that the temperature always remains below the boiling point corresponding to the pressure of the carbon dioxide. This method also inhibits evaporation of liquid carbon dioxide when no liquid carbon dioxide is flowing.

The invention is particularly suitable for supplying sinks with carbon dioxide which is “warm”, in the region of ambient temperature, at elevated pressure. A preferred field of application is the temperature-control and cooling of injection molds with liquid carbon dioxide, in particular with carbon dioxide with a pressure of about 60 bar and with a temperature of about 15° C. However, the inventive method can also be used, for example, for supplying CO₂ expansion nozzles for blow molding or internal extrusion cooling, or generally in processes in which carbon dioxide is depressurized from a high pressure region of more than 50 bar for cooling purposes.

### BRIEF DESCRIPTION OF THE DRAWINGS

Inventive examples shown in the drawings are used below for closer illustration of the invention, and also further details of the invention.

FIG. 1 shows an inventive apparatus for supplying extruders with liquid carbon dioxide and

FIG. 2 shows an alternative design of the supply concept shown in FIG. 1.

### DETAILED DESCRIPTION OF THE INVENTION

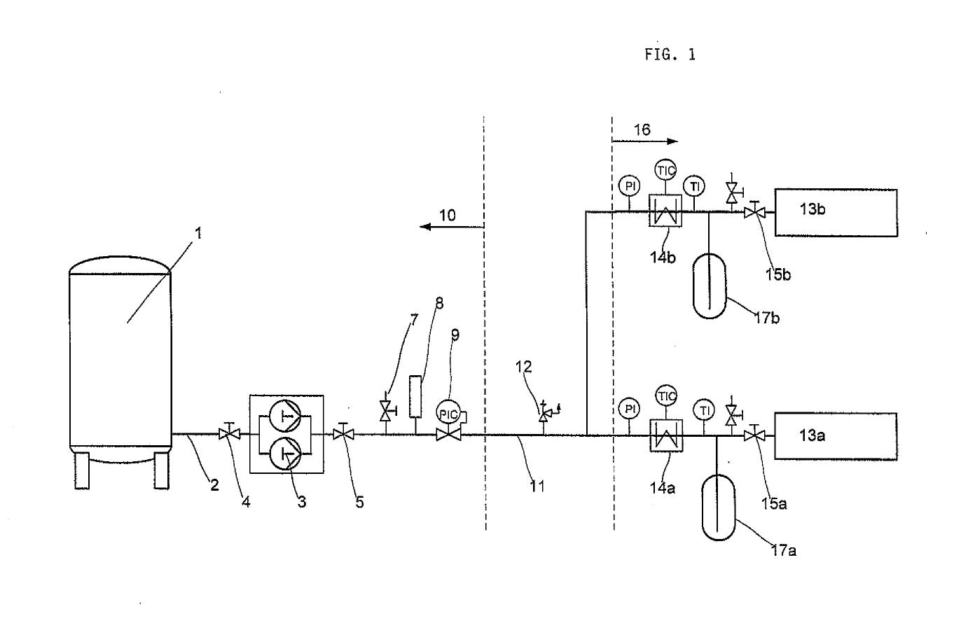

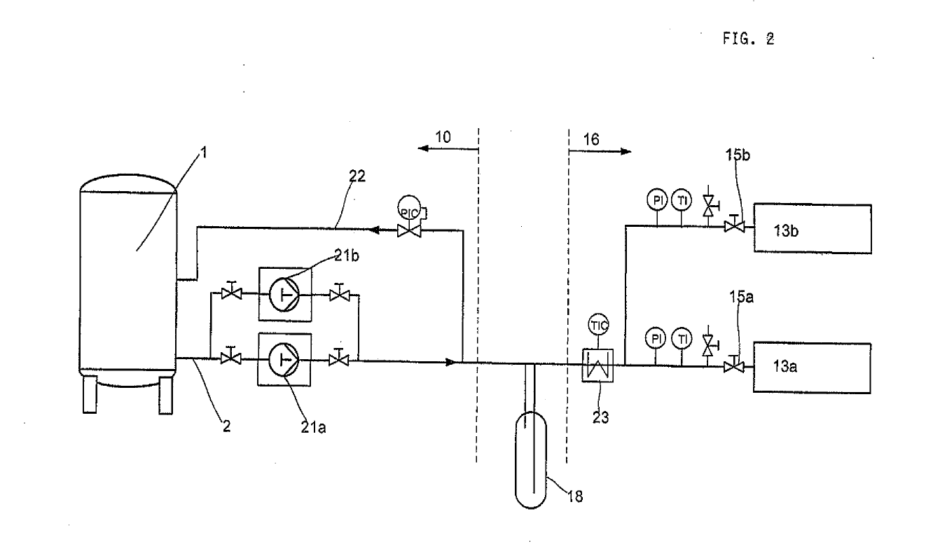

Each of FIGS. 1 and 2 shows an apparatus for supplying molds, in particular injection molds or injection-molding machinery, with liquid carbon dioxide. The liquid carbon dioxide is needed for cooling the injection molds.

FIG. 1 shows an apparatus operating by the inventive method. In a low-pressure tank 1 liquid carbon dioxide is stored with a pressure of 20 bar and with a corresponding boiling point of about −20° C. Tank 1 has been designed as a vacuum-insulated tank, but can also have foam insulation. At the lower end of the tank 1 an extraction line 2 has been attached, by way of which liquid carbon dioxide can be taken from the tank 1.

Connected to the extraction line 2 there is a compressor unit 3. Prior to and behind the compressor unit 3 there are respectively valves 4, 5 installed. By means of the compressor unit 3, carbon dioxide drawn off from the tank 1 is compressed to an elevated pressure of from 40 to 90 bar, preferably from 50 to 70 bar.

Downstream of the valves 5a, 5b the two lines a, b are in turn combined to give a shared line. In the shared line, a deaerating valve 7, a stabilizing vessel 8, and also a pressure controller 9 have been arranged in series.

The arrangement described hitherto can be summarized as tank-side installation 10. In particular, the location of the compressor unit 3 is in the immediate vicinity of the tank 1, and this means that the length of the extraction line 2 is kept very short upstream of the compressor unit 3, the length of the extraction line 2 preferably being less than 1 meter, in order to inhibit evaporation of liquid carbon dioxide in the extraction line 2 between tank 1 and the compressor unit 3.

The tank-side installation 10 is followed by a high-pressure line 11, which has been provided with a safety valve 12 and leads to the injection-molding machines 13a, 13b which are to be supplied with carbon dioxide. Installed prior to each of the injection-molding machines 13a, 13b there are respectively an electrical heater 14a, 14b and a controllable magnetic valve 15a, 15b.

The dimensioning of the electrical heaters 14a, 14b is such that in batchwise operation, too, no liquid evaporates. This is achieved in that the liquid carbon dioxide is passed through a metal block, preferably an aluminum block, whose temperature is adjusted appropriately for the pressure of the carbon dioxide after the compressor unit 3. The temperature of the metal block is precisely controlled in such a way that no liquid carbon dioxide evaporates when no carbon dioxide is flowing. The heaters 14a, 14b have moreover been arranged sufficiently close to the injection-molding machines 13a, 13b that no evaporation of the carbon dioxide can occur prior to entry into the injection-molding machines 13a, 13b, even after heating. The arrangement of the heaters 14a, 14b, of the magnetic valves 15a, 15b and of the associated measurement and control fittings can therefore be summarized as sink-side installation 16.

The carbon dioxide taken from the tank 1 at a pressure of 20 bar and at a temperature of about −20° C. is brought to an elevated pressure of from 40 to 90 bar, preferably 60 bar, in the compressor unit 3. The temperature of the carbon dioxide is, in contrast, only insignificantly increased during the compressing process, a result being that the carbon dioxide is in markedly subcooled state, and this means that the temperature is markedly below the boiling point corresponding to the elevated pressure.

In this subcooled state, the liquid carbon dioxide is supplied to the injection-molding machines 13a, 13b to be cooled. By virtue of the marked subcooling, no evaporation of liquid carbon dioxide can take place during transport through the high-pressure line 11. The degree of subcooling here can be adjusted by way of the compressor unit 3 in such a way that even at relatively high ambient temperatures such as those that can prevail in summer in production buildings no carbon dioxide evaporates.

The subcooled carbon dioxide is then brought to the desired required temperature in the heaters 14a, 14b. For the cooling or temperature-control of injection-molding machines 13a, 13b it has proven advantageous to heat the carbon dioxide to 15° C.

The cooling of the injection-molding machines 13a, 13b is controlled by way of time-cycling of the magnetic valves 15a, 15b. By virtue of the inventive procedure, liquid carbon dioxide with defined conditions, for example 60 bar and 15° C., is always available at the magnetic valves 15a, 15b. This ensures reproducibly uniform cooling of the injection-molding machines 13a, 13b, even when ambient temperatures vary.

Immediately prior to the injection-molding machines 13a, 13b there are in each case siphon-tube bottles 17a, 17b provided as buffer vessels. The capacity of the siphon-tube bottles is from 10 to 30 kg of carbon dioxide. The injection-molding machines 13a, 13b can immediately be supplied with liquid carbon dioxide from the buffer vessels 17a, 17b. During times when the injection-molding machines 13a, 13b need no carbon dioxide, this can be placed into intermediate storage in the buffer vessels 17a, 17b, in order to have liquid carbon dioxide available as quickly as possible when needed.

FIG. 2 shows an alternative embodiment of the invention in which, instead of the compressor station 3, pumps 21a, 21b are used. Otherwise, identical components have identical reference numerals in the two FIGS. 1 and 2.

In the arrangement according to FIG. 2, the liquid carbon dioxide is preferably stored in a foam-insulated storage tank 1 with closed-circuit cooling units with a pressure of 20 bar and with a corresponding boiling point of −20° C. By way of the extraction line 2, liquid carbon dioxide is drawn off from the tank 1 and supplied to one of two liquid pumps 21a, 21b arranged in parallel. Centrifugal pumps or reciprocating pumps are used as liquid pumps 21a, 21b. By means of the liquid pumps 21a, 21b the liquid carbon dioxide is compressed to a pressure of, for example, 60 bar.

Conventional liquid pumps 21a, 21b have to be constantly supplied with liquid, in this case specifically with liquid carbon dioxide. It is therefore necessary to return the compressed carbon dioxide by way of a ring line 22 in the circulation system into the tank 1. The carbon dioxide flow rate in the circulation system must be sufficiently great by way of the ring line 22 that even when consumption is at maximum, i.e. when the magnetic valves 15a, 15b are feeding the maximum amount of carbon dioxide to the injection-molding machines 13a, 13b, liquid carbon dioxide is constantly still conducted back into the tank 1. The returned carbon dioxide is recooled before passage into the tank 1.

If one of the two magnetic valves 15a, 15b which control the inflow of liquid carbon dioxide to the injection-molding machines 13a, 13b should open, compressed liquid carbon dioxide is supplied to a heater 23 and heated to the required temperature of, for example, 15° C. or 20° C. The liquid carbon dioxide with the desired required temperature and with the desired required pressure of, for example, 60 bar, then enters the injection-molding machine 13a, 13b.

In FIG. 2, a shared buffer vessel 18 supplying all of the injection-molding machines has been provided instead of the separate buffer vessels 17a, 17b shown in FIG. 1. The buffer vessel 18 has been designed as a collection of siphon-tube bottles.

The design shown in FIG. 2 with only one heater 23, which supplies both of the injection-molding machines 13a, 13b, and/or the provision of a shared buffer vessel 18, can also be used in the design of FIG. 1. Conversely, of course, it is also possible to use separate heaters and/or separate buffer vessels 17a, 17b for each branch of the line and, respectively, for each injection-molding machine 13a 13b in the arrangement of FIG. 2.

What is claimed is:

1. A method for the supply of a sink with liquid carbon dioxide with a desired temperature of more than 0° C. and a desired pressure of more than 30 bar, characterized in that the carbon dioxide is taken from a tank in which the liquid carbon dioxide is stored at a temperature below the desired temperature and a pressure below the desired pressure, that the pressure of the carbon dioxide is increased and that subsequently the carbon dioxide is heated to the desired temperature in the immediate vicinity of the sink.

2. The method according to claim 1 wherein said immediate vicinity is less than 2 meters.

3. The method according to claim 1 wherein said immediate vicinity is less than 1 meter.

4. The method according to claim 1, characterized in that the pressure of the carbon dioxide is increased to 40 to 90 bar.

5. The method according to claim 1, characterized in that carbon dioxide is heated to a temperature of 5° C. to 25° C.

6. The method according to claim 1, characterized in that the carbon dioxide is heated by means of an electrically operated heater.

7. The method according to claim 1, characterized in that the carbon dioxide following the pressure increase is directed to the sink via a tie line.

8. The method according to claim 1, characterized in that following the pressure increase a part of the carbon dioxide is redirected into the tank and a part of the carbon dioxide is supplied to the sink.

9. The method according to claim 1, characterized in that said sink is an injection moulding machine and said carbon dioxide is at a temperature of about 15° C.

10. The method according to claim 9, characterized in that said carbon dioxide is at a pressure of about 60 bar.

11. The method according to claim 1, characterized in that carbon dioxide is depressurized from a high pressure region of more than 50 bar.

12. A device for the supply of a sink with liquid carbon dioxide with a desired temperature of more than 0° C. and a desired pressure of more 30 bar, characterized through a single tank in which the liquid carbon dioxide is stored at a temperature below the desired temperature and a pressure below the desired pressure, a supply line connecting the single tank with the sink, a pressure boosting apparatus to increase the pressure of the carbon dioxide supplied to the sink wherein said pressure boosting apparatus is within 1 meter of said single tank and said carbon dioxide is in a state of equilibrium prior to said pressure increase and a heater arranged downstream of the pressure boosting apparatus for heating the carbon dioxide according to the requirements of the sink.

13. The device according to claim 12, characterized in that the heater comprises a metal block through which the carbon dioxide is directed.

14. The device according to claim 13, characterized in that said metal block is an aluminium block.

15. The device according to claim 12, characterized in that the metal block temperature is controlled such that the temperature remains below the boiling point corresponding to the pressure of the carbon dioxide.

16. The device according to claim 12, characterized in that a hydraulically or pneumatically operated compressor is employed as pressure boosting apparatus.
